(19) United States
(12) Patent Application Publication
(10) Pub. No.: US 2026/0233136 A1
(43) Pub. Date: Aug. 13, 2026

(54) PURIFICATION MEDIA HOUSING, PURIFIER COMPRISING THE SAME, AND METHOD OF FABRICATING THE SAME

(71) Applicant: MOTT CORPORATION, Farmington, CT (US)

(72) Inventors: Nathan Donahue, Kensington, CT (US); Vincent Palumbo, East Granby, CT (US); Alen Uvalic, West Hartford, CT (US); Derek Tsaknopoulos, Tolland, CT (US)

(21) Appl. No.: 19/533,652

(22) Filed: Feb. 9, 2026

Related U.S. Application Data
(60) Provisional application No. 63/756,588, filed on Feb. 10, 2025.

(51) Int. Cl. B01D 35/30; B01D 67/00

(52) U.S. Cl. CPC B01D 35/30; B01D 67/00415; B01D 2201/30; B01D 2253/102; B01D 2253/108; B01D 2253/342; B01D 2313/2062

(57) ABSTRACT

A purification media housing including a monolith shaped to hold purification media, wherein the monolith includes a material having a nominal pore size of 0.1 to 80 micrometers and a porosity of 10% to 60%.

### CROSS REFERENCE TO RELATED APPLICATION

This application claims priority to U.S. Provisional Patent Application No. 63/756,588, filed on February 10, 2025, the contents of which are hereby incorporated by reference in their entirety.

### FIELD OF THE DISCLOSURE

The present disclosure relates to purification media housings and purifiers and related methods of fabrication and use and, more particularly, to purification media housings and purifiers fabricated at least in part by additive manufacturing (e.g., via a three-dimensional (3D) printing process, such as, for example, via a laser powder bed fusion (LPBF) process, via an electron-beam melting (EBM) process, via an inkjet or a binder-jet additive manufacturing process, etc.).

### BACKGROUND OF THE DISCLOSURE

Purifiers, for example, point-of-use, in-line, and for surface mount purification applications, can have application in the semiconductor industry, where small quantities of purification media can remove the last few parts-per-billion of impurities from a process gas stream. Purifier beds can be quite small relative to other purifiers, for example, containing less than 100 cubic centimeters of purification media by volume.

Purifier designs can include an open cavity filled with purification media through which fluid can flow. Grids can be installed via welding to provide structural integrity and reduce compaction and erosion of the purification media. To form a purifier, a purification media housing and additional hardware can be welded onto an external housing, the purification media housing can be filled with the purification media, and then end caps, connections, or a combination thereof can be welded to more hardware. Inside the purification media housing, the purification media may shuffle around, settle out, and compact during use, which, over time, can render the purifier less efficient.

Inefficient use of the open cavity can lead to the purifier bed not being fully utilized, poor gas distribution, purifier bed by-pass whereby fluid does not come into contact with the purification media, excessive pressure drop, or a combination thereof. An interest exists for improved purifiers and related methods of fabrication and use.

These and other inefficiencies and opportunities for improvement are addressed and/or overcome by the purification media housings, purifiers, systems, and methods of the present disclosure.

### BRIEF SUMMARY OF THE DISCLOSURE

The present disclosure provides advantageous purification media housings and purifiers, and improved systems/methods for utilizing and/or fabricating the purification media housings and purifiers. More particularly, the present disclosure provides purification media housings and purifiers fabricated at least in part by additive manufacturing (e.g., via a 3D printing process, such as, for example, via an LPBF process, via an EBM process, via an inkjet or a binder-jet additive manufacturing process, etc.), thereby providing operational, manufacturing, commercial and/or revenue advantages as a result, and as discussed further herein.

Disclosed is a purification media housing including a monolith shaped to hold purification media, wherein the monolith includes a material having a nominal pore size of 0.1 to 80 micrometers (μm) and a porosity of 10% to 60%.

The above described and other features are exemplified by the following figures and detailed description.

Any combination or permutation of embodiments is envisioned. Additional advantageous features, functions and applications of the disclosed assemblies, systems and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

The following figures are exemplary embodiments wherein the like elements are numbered alike.

Features and aspects of embodiments are described below with reference to the accompanying drawings, in which elements are not necessarily depicted to scale.

Exemplary embodiments of the present disclosure are further described with reference to the appended figures. It is to be noted that the various features, steps, and combinations of features/steps described below and illustrated in the figures can be arranged and organized differently to result in embodiments which are still within the scope of the present disclosure. To assist those of ordinary skill in the art in making and using the disclosed assemblies, systems and methods, reference is made to the appended figures, wherein:

FIG. 1 is a cross-sectional perspective view of an exemplary purification media housing and purifier, according to the present disclosure.

FIG. 2 is a cross-sectional perspective view of an exemplary purification media housing and purifier, according to the present disclosure.

FIG. 3 is a perspective view of the purification media housing and purifier of FIG. 1.

FIG. 4 is a perspective view of the purification media housing and purifier of FIG. 1.

### DETAILED DESCRIPTION OF THE DISCLOSURE

The exemplary embodiments disclosed herein are illustrative of advantageous purification media housings and purifiers, and systems of the present disclosure and methods/techniques thereof. It should be understood, however, that the disclosed embodiments are merely exemplary of the present disclosure, which may be embodied in various forms. Therefore, details disclosed herein with reference to exemplary purification media housings and purifiers and associated processes/techniques of fabrication/assembly and use are not to be interpreted as limiting, but merely as the basis for teaching one skilled in the art how to make and use the advantageous purification media housings and purifiers and/or alternative assemblies of the present disclosure.

The present disclosure provides advantageous purification media housings and purifiers, and improved systems/methods for utilizing and/or fabricating the purification media housings and purifiers. More particularly, the present disclosure provides purification media housings and purifiers fabricated at least in part by additive manufacturing (e.g., via a 3D printing process, such as, for example, via an LPBF process, via an EBM process, via an inkjet or a binder-jet additive manufacturing process, etc.).

Additive manufacturing allows for creation of custom purification media housings and purifiers. Such purifiers can be on the order of 3 inches (7.62 centimeters) tall and 1 inch (2.54 centimeters) in diameter. Additive manufacturing allows for efficient packing of purification media within an exterior housing of the purifier, without the creation or presence of by-pass paths, and minimization of dead volume in the purifier. As used herein, the phrase “by-pass” refers to fluid not coming into contact with purification media. The disclosed purification media housings formed by additive manufacturing can provide improved utilization of internal space of the purifier and uniform gas distribution during use of the purifier. Improvements provided by the disclosed purification media housings can result in extremely high levels of purification.

Additively manufacturing a purification media housing can allow for formation of a monolith shape to hold purification media wherein the monolith is porous. The shaped monolith being porous can reduce the pressure drop between ends of the monolith as fluid flows from a first end of the monolith, through the monolith containing purification media, to a second end of the monolith. Such pressure drop could otherwise be significant and unwanted and negatively affect performance of the purifier. The shape of the monolith can provide increased flow paths as the fluid flows from the first end of the monolith, through the monolith containing purification media, to the second end of the monolith.

The monolith can, for example, have corrugated walls, have a lattice structure, be in the form of a repeating geometrical element, such as a gyroid, or a combination thereof. The shape of the monolith can reduce or eliminate dead spaces within the monolith containing the purification media. Dead spaces are areas where gas flow is minimal or nonexistent and can gather debris.

As used herein, a lattice structure is a topologically ordered, three-dimensional open-celled structure composed of one or more repeating unit cells. The lattice structure can fill a volume or conform to a surface. An exemplary lattice structure is a gyroid, which is a triply periodic minimal surface. Other lattice structures include diamond, I-graph-wrapped package (IWP), and primitive structures. The monolith can be in a form of a gyroid, for example, including walls having a thickness of 0.01 to 0.125 inches (0.25 to 3.18 millimeters).

Each unit cell can include a plurality of trusses integrally connected with each other at respective ends thereof and that define interstitial spaces. The trusses can be present within an internal space of the monolith. As used herein, the term “truss” means a structural member of a framework defining the unit cell(s). The trusses can have a thickness of 0.0625 to 0.125 inches (1.59 to 3.18 millimeters). Trusses may be fully dense articles or porous articles having a pore size in the range of 0.1 to 80 μm and a porosity of 10% to 60%. The upper limit of pore size, e.g., maximum pore size, of the trusses, the repeating geometrical element, or a combination thereof can be chosen, e.g., configured, based on a particle size of the purification media, so as to minimize gas by-pass, e.g., not to create a by-pass flow through the trusses and other lattice elements as described herein. Maximum pore size can be less than or equal to 1/25^{th} of a smallest dimension of purification media particles.

An end of an exterior housing of the purifier formed by additive manufacturing, e.g., a portion of the exterior housing formed first during additive manufacturing, also referred to herein as a base of the exterior housing, can be a porous outlet that can filter out debris, prevent purification media from breaking through, e.g., exiting, the purifier and entering downstream, e.g., a stream exiting the purifier, or a combination thereof. Forming an end of the exterior housing by additive manufacturing avoids the need for a welding process to attach a filter to an end of the exterior housing.

The monolith can reduce erosion of the purification media from fluid flow, and reduce the likelihood of by-pass paths. Bypass paths can be created over time, for example, by movement, shuffling, settling, compaction, or a combination thereof of the purification media, or a combination thereof. Purification media within the lattice can be tightly packed, which can prevent shuffling and other movement of the purification media within the lattice, which otherwise can cause the purification media to break into smaller particles. The monolith can also reduce the likelihood of by-pass paths, which can be paths of least resistance for gas flow, instead of evenly dispersing throughout the purification media, leading to better purification efficiency and longer lifespan. The monolith can hold the purification media in place, reducing or preventing movement, compaction, or a combination thereof, of the purification media in the purification media housing. The lifetime of the purifier can be extended.

As used herein, the term “unitary,” “monolith,” or “monolithic,” for example, a unitary component or a monolith or monolithic structure, refers to a three-dimensional construction, e.g., one body, that can be formed from portions that can have substantially identical or identical compositions. A monolith can be made of a single, continuous material, e.g., thermoplastic, metal, or ceramic material, and can be manufactured using various techniques, including injection molding, compression molding, and extrusion. Accordingly, a unitary component differs from a laminate or assembly of differing constituents, which includes an interface between differing constituents thereof. A unitary component can be integrally formed, for example, integrally molded in a single mold. Similarly, as used herein, portions can be “integrally formed,” or one portion can be “integrally formed” with a different portion, resulting in a unitary component differing from a laminate or assembly of differing constituents, which includes an interface between differing constituents thereof.

The purifier can be utilized as an in-line purifier or modified to serve as a surface mount purifier. The surface mount purifier can include an inlet including a 3D printed dip tube with a porous plug of the purification media housing to help prevent purification media from entering/blocking the inlet. The purifier can be printed via LPBF and cut from the build plate. To clean and remove loose powder following printing, the purifier can be mechanically vibrated, sonicated in isopropyl alcohol, heat treated, or a combination thereof. The plug can be a porous membrane before the outlet of the purifier to act as a filter and prevent any shedding from the purification media or any other debris from getting through the purifier.

In an aspect, the flow path of the fluid through the purifier is created by a high pressure stream, e.g., a high pressure gas stream. The pressure can be less than or equal to 1,000 pounds per square inch (psi) (6.89 megapascals (MPa), less than or equal to 100 psi (0.69 MPa), or less than or equal to 25 (0.17 MPa). The purifier can be used, for example, at a temperature of less than or equal to 400° C.

Provided is a purification media housing that can be used in purifiers, for example, used in semiconductor manufacturing. The purifier described herein can provide a high purity fluid from which impurities, contaminants, or a combination thereof are removed.

In an aspect, the purifier is used for semiconductor manufacturing. The purifier achieves 9 Log Reduction Value (LRV) filtration down to 0.003 μm. The disclosed purifier can provide efficient removal of impurities, contaminants, or a combination thereof from fluids. The fluids which can be filtered by the disclosed purification media housing and purifier include both liquids and gases. The fluids include high purity gases, such as, but not limited to, hydrogen bromide, and other high purity fluids.

The disclosed purification media housing and purifier can utilize a LPBF process for the creation of purification media housings that can be used in purifiers that can be used for, or in conjunction with, the purification of fluids (e.g., gases). As used herein, additive manufacturing refers to a 3D printing process whereby successive layers of material are formed to create an object of a desired shape. A LPBF process can employ a laser to melt, soften, sinter or otherwise affect the material used in the object being manufactured. By varying material and manufacturing process specifications and conditions, a desired and tailored pore size, morphology, and distribution can be produced. The resultant monolith can be fabricated with a solid full density external housing to form a purifier.

As used herein, “solid” and “substantially non-porous” are used synonymously to mean a component does not exhibit a through-thickness interconnected porosity. The disclosed LPBF process can be used to create porous monoliths, solid external housings, and purifiers that have both porous monoliths and solid external housings that can be integrally formed together.

The purification media housing can be manufactured with a variety of different pore structures/densities to fit numerous application needs. Pore size and distribution can be important factors. Pore size can help control, for example, pressure drop. The ability to fabricate a predetermined pore size and form of the interconnected pores in a consistent, controllable, and reproducible manner can be a significant advantage offered by LPBF processes. LPBF processes can allow for the ability to design and manufacture purification media housings and purifiers with unique and variable density distributions that can be achieved by precisely controlling the size, structure, and distribution of the pores throughout such purification media housings and purifiers. The disclosed purification media housings and purifiers can be characterized by densities that can be substantially uniform throughout, that vary at a constant rate, or that vary at variable rates.

Capillary flow porometry can be used to measure nominal pore size, minimum, maximum (or first bubble point) and mean flow pore sizes, and pore size distribution. Volume and pore size distribution can be ascertained using mercury porosimetry. Maximum pore size can be calculated using a standard industry bubble-point test as defined by, for example, ISO 4003 or ASTM E128. The disclosed purification media housing and purifier may define pores having a wide distribution of sizes. As used herein, nominal pore size refers to a filter capable of preventing passage of a minimum percentage (e.g., 60% to 90%) of solid particles of greater than the stated pore size. The disclosed purification media housing or monolith can include a material having a nominal pore size of 0.1 to 80 µm, for example, 0.1 to 5 µm, and a porosity of 10% to 60%.

The pore size of purification media housings created through LPBF processes can be controlled, for example, through powder recipe and machine parameters, for example as taught in US2017/0239726 A1, Palumbo et al. Layers with different size pores between and among the layers can be produced. Materials, pore sizes, thicknesses, and areas of the purification media housing can be varied.

For example, a method of fabricating the purification media housing can include placing a first layer of particles on a build plate; subjecting the particles in at least a first portion of the first layer to a laser beam such that at least a portion of the particles in the first layer bind to each other without fully melting; placing a second layer of particles over the first layer; subjecting the particles in at least a first portion of the second layer to a laser beam such that at least a portion of the particles in the second layer bind to each other and to at least a portion of the first layer without fully melting; and placing subsequent layers of particles over the second layer to form the purification media housing, and subjecting at least a portion of each subsequent layer to a laser beam such that at least a portion of the particles in each of the subsequent layers bind to each other without fully melting. The build plate can be non-porous and the step of subjecting the particles in at least a portion of the first layer to a laser beam results in binding at least a portion of the first layer to the build plate; and wherein the build plate is an integral portion of the purification media housing.

Exemplary materials for use in forming the disclosed purification media housing and purifier include materials such as, for example, nickel, cobalt, iron, copper, aluminum, palladium, titanium, tungsten, platinum, silver, gold, and alloys and oxides thereof including stainless steels such as 316L stainless steel and nickel-based steels such as Hastelloy® (Haynes Stellite Company, Kokomo, Ind.). Various polymer or ceramic materials can also be used if operating at lower pressures and temperatures.

Following printing of the purification media housing, the purification media housing can be filled with a desired purification media. Exemplary purification media for use with the disclosed purifier include, for example, zeolite, activated carbon, or a combination thereof. The purification media is dependent on the application of use and multiple medias and particle sizes can be used. Thereafter, an end of the purification media housing containing the purification media can be sealed with a plug as disclosed herein. After the purification media is inserted, the plug can be welded on and the entire assembly can be completed.

In an aspect, purification media housings and purifiers can be fully processed using LPBF processes, which can be used to provide a smooth transition from the porous purification media housing of the purifier to a full density (solid, substantially non-porous) exterior housing of the purifier, which can surround the purification media housing. Joints between the porous purification media housing and the solid exterior housing can be reduced, a risk by-pass paths can be reduced, and joining and integrating techniques can be reduced. The use of LPBF processes can allow for the manufacturing of purifiers that have a porous purification media housing and solid exterior housing within a single additively manufactured build process.

Additively manufacturing a purifier, including a purification media housing, can allow the purification media housings to be integrated with exterior housings, reducing the number of welds, assembly lead times, and material costs. Grids that may otherwise be included in the purifier to provide structural integrity and reduce compaction and erosion of the purification media can be eliminated, along with associated welding of the grids. With additive manufacturing, the shape of the monolith can be customized for various purifier designs/applications.

Following manufacture of the purification media housing, purification media can be added therein, and threaded connections such as Swagelok, compression, or VCR fittings can be welded on and the purifier can be plumbed into a gas flow system.

In an aspect, the purification media housing can be centrally located in the exterior housing. In an aspect, the purification media housing can be located off-center and towards one side of the purification media housing. The purification media housing can be positioned towards one end of the exterior housing.

The purifier can have two fittings. In an aspect, the purifier can have one fitting. One fitting can be located at a first end of the exterior housing and a second fitting can be located at a second end of the exterior housing. In an aspect, the fittings are fluid fittings. The fluid fittings can be in fluid communication with the purification media housing. The fluid fittings can provide inlet and outlet ports to the purifier. For example, the purifier can use high pressure to supply or flow a fluid (i.e., gas) into the inlet port of a fitting, through the exterior housing and through the purification media housing. The high pressure can be used to purify the fluid so that the impurities, contaminates, or a combination thereof are filtered by the purification media housing and only the filtered fluid exits through the outlet port of the fitting.

In an aspect, a fluid can enter the purifier through the fittings. The purifier can use high pressure to cause the fluid to enter the inlet port of the fitting. The filtered fluid can be released via the outlet port of fitting.

Referring now to the drawings, like parts are marked throughout the specification and drawings with the same reference numerals, respectively. Drawing figures are not necessarily to scale and in certain views, parts may have been exaggerated for purposes of clarity.

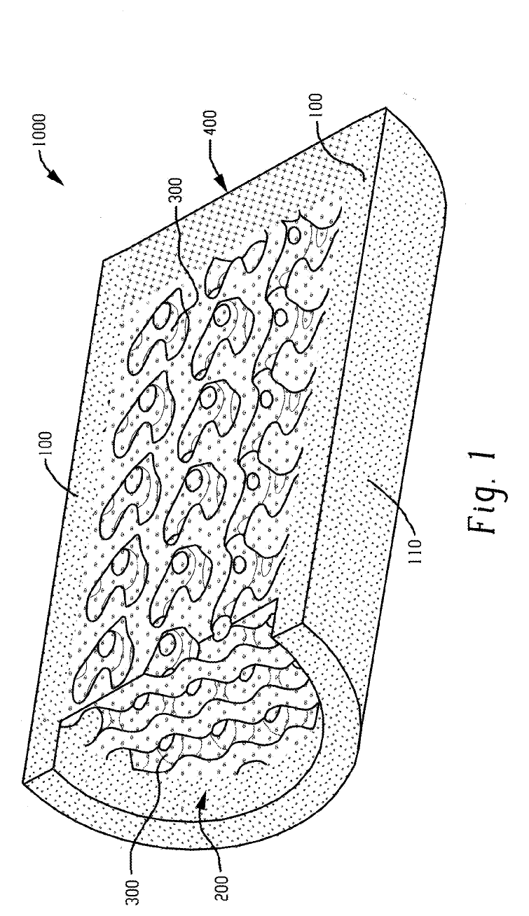

FIG. 1 is a cross-sectional perspective view of an exemplary purification media housing and purifier. The purifier 1000 includes an exterior housing 100 having an outer surface 110 and an internal space 200 and the purification media housing 300 disposed within the internal space 200 of the exterior housing 100. The purification media housing 300 includes a monolith shaped to hold purification media. FIG. 1 does not show purification media disposed within the monolith.

The exterior housing 100 and the purification media housing 300 or monolith can form, e.g., be, a unitary component. The exterior housing 100 can include a porous base 400 that is formed first during additive manufacturing, and can be porous and filter out debris, prevent purification media from breaking through the purifier and entering downstream, or a combination thereof. The exterior housing 100, for example, the porous base 400, can have a nominal pore size (for example, 0.1 to 80 µm or 0.1 to 5 µm) that is less than the nominal pore size of the monolith. The porous base 400 can have a porosity, e.g., nominal pore size, that is the same as or different from that of a remainder of the exterior housing 100.

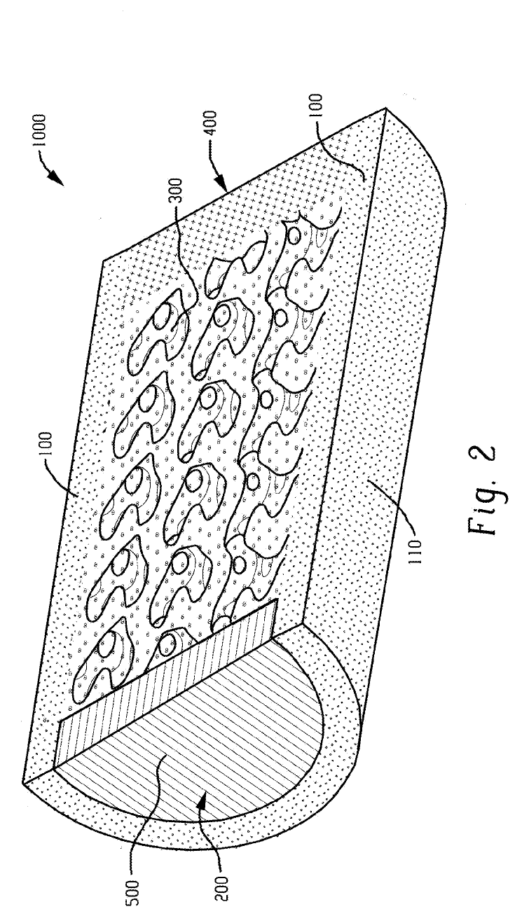

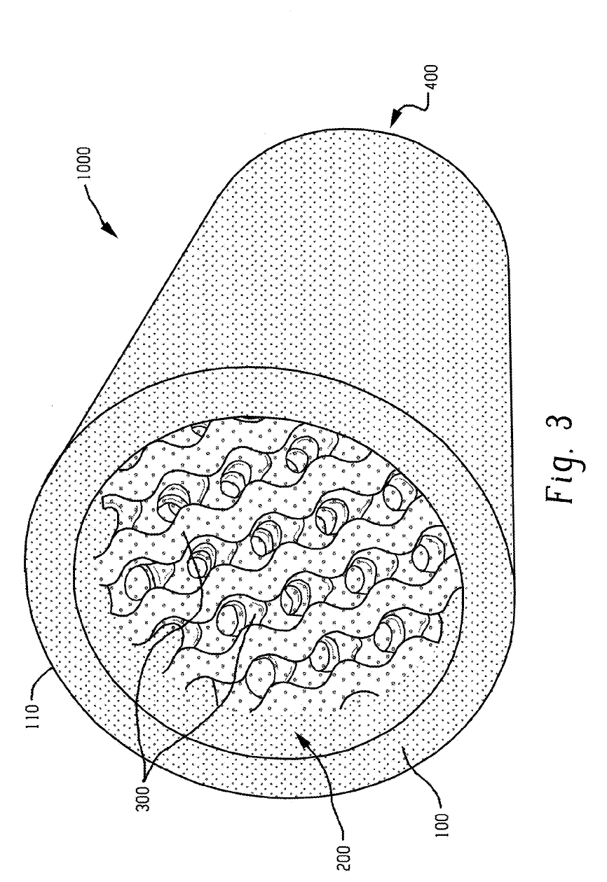

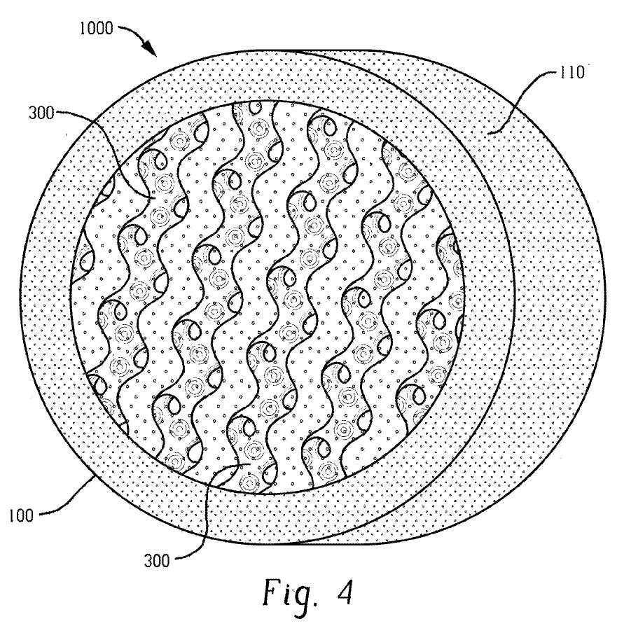

FIG. 2 is a cross-sectional perspective view of an exemplary purification media housing and purifier, to which a porous plug 500 that can retain purification media within the purification media housing 300 has been added (after addition of purification media to the purifier 1000). The purification media housing 300 can be dimensioned such that an internal space of the exterior housing 100 is present at an end of the purification media housing 300 opposite the porous base 400. The porous plug 500 can be dimensioned to fit within the internal space of the exterior housing 100 present at the end of the purification media housing 300 opposite the porous base 400. The porous plug 500 can have a porosity, e.g., nominal pore size, that is the same as or different from that of the porous base 400, a remainder of the exterior housing 100 not including the porous base, or a combination thereof. Each of FIG. 3 and FIG. 4 is a perspective view of the purification media housing and purifier of FIG. 1.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

The ranges disclosed herein are inclusive of the endpoints, and the endpoints are independently combinable with each other (e.g., ranges of “up to 25 wt.%, or, more specifically, 5 wt.% to 20 wt.%”, is inclusive of the endpoints and all intermediate values of the ranges of “5 wt.% to 25 wt.%,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A purification media housing comprising:
a monolith shaped to hold purification media,
wherein the monolith comprises a material having a nominal pore size of 0.1 to 80 micrometers and a porosity of 10% to 60%.

2. The purification media housing of claim 1, wherein the monolith comprises stainless steel.

3. The purification media housing of claim 1, wherein the monolith comprises trusses within an internal space of the monolith.

4. The purification media housing of claim 3, wherein the trusses have a thickness of 0.0625 to 0.125 inches (1.59 to 3.18 millimeters).

5. The purification media housing of claim 1, wherein the monolith is in a form of a repeating geometrical element.

6. The purification media housing of claim 5, wherein the repeating geometrical element is in a form of a gyroid.

7. The purification media housing of claim 1, wherein:
the monolith comprises a repeating geometrical element; and
the repeating geometrical element comprises walls having a thickness of 0.01 to 0.125 inches (0.25 to 3.18 millimeters).

8. The purification media housing of claim 1, wherein:
the monolith comprises trusses within an internal space of the monolith;
the trusses have a thickness of 0.0625 to 0.125 inches (1.59 to 3.18 millimeters);
the monolith is in a form of a repeating geometrical element; and
a maximum pore size of the trusses, the repeating geometrical element, or a combination thereof is configured to minimize gas by-pass.

9. The purification media housing of claim 1, wherein:
the monolith comprises trusses within an internal space of the monolith;
the trusses have a thickness of 0.0625 to 0.125 inches (1.59 to 3.18 millimeters);
the monolith is in a form of a repeating geometrical element;
the purification media comprises particles; and
a maximum pore size of the trusses, the repeating geometrical element, or a combination thereof is less than or equal to 1/25^{th} of a smallest dimension of the particles.

10. A purifier comprising:
an exterior housing having an outer surface and an internal space;
the purification media housing of claim 1 disposed within the internal space of the exterior housing; and
the purification media disposed within the monolith.

11. The purifier of claim 10, wherein the exterior housing and the monolith comprise a unitary component.

12. The purifier of claim 11, wherein the exterior housing comprises a porous base.

13. The purifier of claim 12, wherein the porous base has a nominal pore size that is less than the nominal pore size of the monolith.

14. The purifier of claim 13, further comprising a porous plug dimensioned to fit within the internal space of the exterior housing present at an end of the purification media housing opposite the porous base.

15. The purifier of claim 12, wherein the porous base has a nominal pore size that is different from a nominal pore size of a remainder of the exterior housing.

16. The purifier of claim 10, wherein the purification media comprises zeolite, activated carbon, or a combination thereof.

17. A method of fabricating the purification media housing of claim 1 comprising:
placing a first layer of particles on a build plate;
subjecting the particles in at least a first portion of the first layer to a laser beam such that at least a portion of the particles in the first layer bind to each other without fully melting;
placing a second layer of particles over the first layer;
subjecting the particles in at least a first portion of the second layer to a laser beam such that at least a portion of the particles in the second layer bind to each other and to at least a portion of the first layer without fully melting; and
placing subsequent layers of particles over the second layer to form the purification media housing, and subjecting at least a portion of each subsequent layer to a laser beam such that at least a portion of the particles in each of the subsequent layers bind to each other without fully melting.

18. The method of claim 17, wherein the build plate is non-porous and the step of subjecting the particles in at least a portion of the first layer to a laser beam results in binding at least a portion of the first layer to the build plate; and wherein the build plate is an integral portion of the purification media housing.
